(19) United States
(12) Patent Application Publication
(10) Pub. No.: US 2025/0280098 A1
(43) Pub. Date: Sep. 4, 2025

(54) DISPLAY METHOD

(71) Applicant: SEIKO EPSON CORPORATION, Tokyo (JP)

(72) Inventor: Taku NAKAMURA, Ina-shi (JP)

(73) Assignee: SEIKO EPSON CORPORATION, Tokyo (JP)

(21) Appl. No.: 19/065,229

(22) Filed: Feb. 27, 2025

(30) Foreign Application Priority Data
Feb. 29, 2024 (JP) 2024-029958

(51) Int. Cl. H04N 9/31; G06F 3/01

(52) U.S. Cl. CPC H04N 9/3185; G06F 3/017; H04N 9/3194

(57) ABSTRACT

A video generator acquires a captured image by causing an imaging device to capture an image of a projection object in a real space. The video generator acquires geometry information indicating a geometry selected by a user from among geometries included in a range of the captured image, and acquires instruction information representing an instruction of the user regarding an expression of content to be displayed in a projection area. The video generator generates, based on the geometry information selected by the user and the instruction information, a first projection image regarding the content for which the expression indicated by the instruction information is implemented with the geometry indicated by the geometry information as a starting point, and causes a projector to project the first projection image.

The present application is based on, and claims priority from JP Application Serial Number 2024-029958, filed Feb. 29, 2024, the disclosure of which is hereby incorporated by reference herein in its entirety.

### BACKGROUND

### 1. Technical Field

The present disclosure relates to a display method.

### 2. Related Art

JP-A-2012-84001 discloses that a projection image to be projected onto a selected object is generated by combining an input image with a predetermined background image. JP-A-2012-84001 discloses that the background image is an image prepared in advance or an image generated in a background image generation unit based on a signal of the input image.

The technique disclosed in JP-A-2012-84001 does not disclose how to select an object to be a projection object of a projection image. In the technique disclosed in JP-A-2012-84001, for example, a two-dimensional object such as a marker or a tape attached to a flat surface may not be selected as the projection object.

JP-A-2012-84001 is an example of the related art.

### SUMMARY

An aspect of a display method according to the present disclosure includes: acquiring a captured image by capturing an image of a projection object in a real space; acquiring geometry information included in a range of the captured image selected by a user; acquiring information regarding an instruction from the user; generating a first projection image showing content to be displayed on the projection object based on the geometry information and the instruction information; and displaying the content by projecting the first projection image onto the projection area.

### BRIEF DESCRIPTION OF THE DRAWINGS

FIG. 1 is a diagram illustrating a configuration example of a system according to an embodiment of the present disclosure.

FIG. 2 illustrates an example of a projection image projected on a projection area from a projector.

FIG. 3 is a diagram illustrating a configuration example of a video generator provided in the system.

FIG. 4 is a diagram illustrating an example of a selection assistance image.

FIG. 5 is a flowchart illustrating a flow of processing in a display method executed by a processing device of the video generator according to a program.

### DESCRIPTION OF EMBODIMENTS

In the embodiment described below, various technically preferable limitations are given. However, embodiments of the present disclosure are not limited to the embodiment described below.

### 1. Embodiment

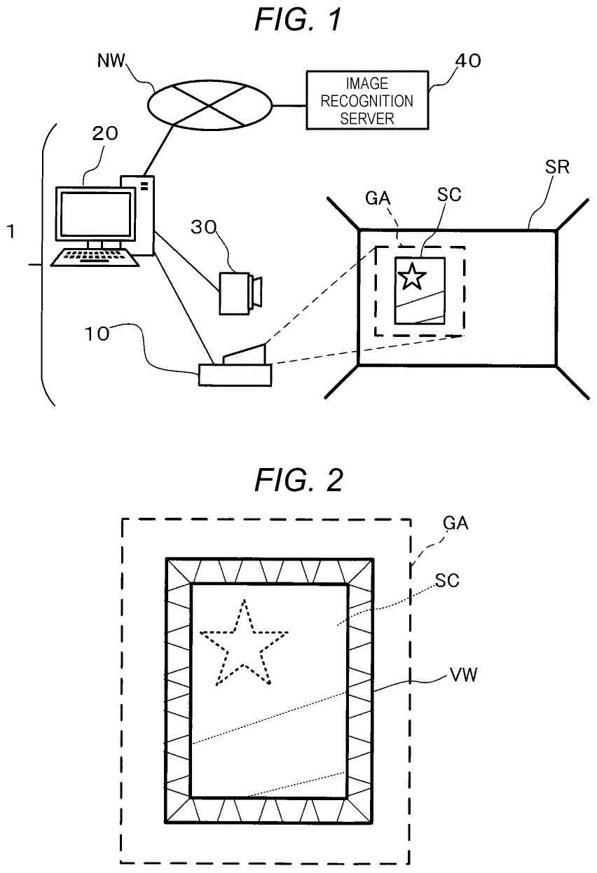

FIG. 1 is a diagram illustrating a configuration example of a system 1 according to an embodiment of the present disclosure. The system 1 is a system that implements projection mapping by projecting a projection image GA onto a projection object SC. As illustrated in FIG. 1, the system 1 includes a projector 10, a video generator 20, and an imaging device 30. The projector 10 and the imaging device 30 are connected to the video generator 20 by wire or wirelessly.

The projector 10 implements projection mapping by projecting the projection image GA, which is represented by image data supplied from the video generator 20, onto a projection area SR in which the projection object SC is disposed. The projection object SC in the embodiment is, for example, a poster, the projection area SR is one of wall surfaces in a room of a user who uses the system 1, and the projection object SC is attached to the wall surface. In the embodiment, as illustrated in FIG. 2, the projection image GA that provides a virtual frame VW around the projection object SC is projected by the projection mapping described above. In FIG. 2, the projection object SC is drawn by a dotted line. The room having the wall surface to which the projection object SC is attached is an example of a real space in the present disclosure, and the projection image GA representing the virtual frame VW is an example of a first projection image in the present disclosure. The virtual frame VW is an example of content in the present disclosure. The projection object SC in the embodiment is a poster, and may be a painting, an illustration, or a photograph, or may be a marker, a tape, or the like attached to the projection area SR. The projection object SC in the present disclosure is not limited to a two-dimensional object such as a poster, and may be a three-dimensional object having a three-dimensional shape.

The imaging device 30 is, for example, a camera, captures an image of the projection area SR, and supplies captured image data representing the captured image to the video generator 20. The video generator 20 is, for example, a personal computer. The video generator 20 generates content data representing the projection image GA to be projected onto the projection area SR from the projector 10, based on the captured image data supplied from the imaging device 30 and an instruction given by the user.

The video generator 20 communicates with an image recognition server 40 via a network NW such as the Internet. The image recognition server 40 is a device that recognizes a type of an object present in a range of an image represented by image data received via the network NW, recognizes a plane, a line, and a point (hereinafter, geometry) that define a contour of the object, and returns geometry information indicating recognized geometry to a transmission source of the image data for each recognized object. Regarding a method of recognizing geometry in the image recognition server 40, an existing technique can be appropriately adopted. In the embodiment, by causing the user to select any one of a plurality of geometries recognized by the image recognition server 40 and causing the user to designate an expression of content with the geometry as a starting point, content data representing content for which the expression is performed with the geometry as a starting point is generated by the video generator 20.

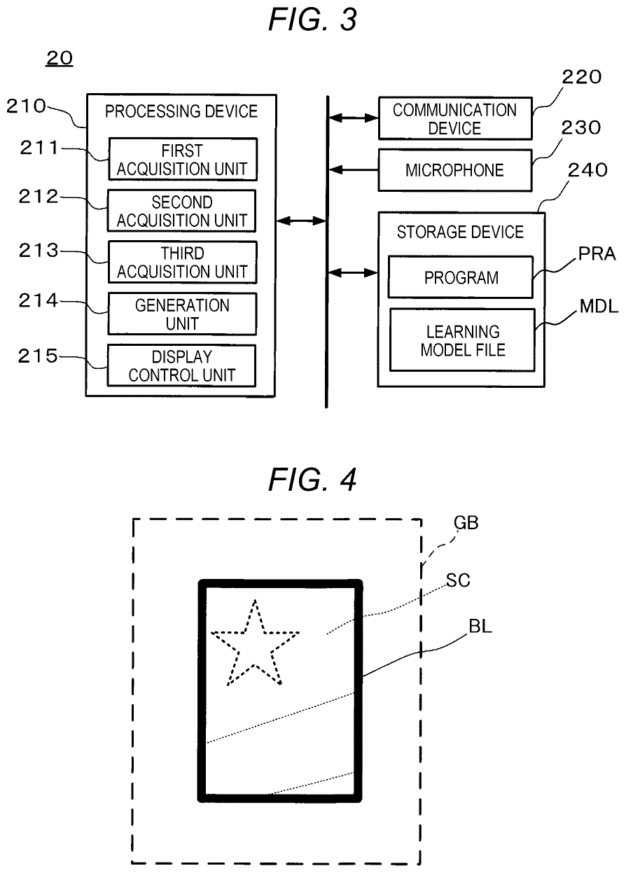

FIG. 3 is a diagram illustrating a configuration example of the video generator 20. As illustrated in FIG. 3, the video generator 20 includes a processing device 210, a communication device 220, a microphone 230, and a storage device 240. The processing device 210 is one or more processors. The processing device 210 is, for example, a central processing unit (CPU). The processing device 210 operates according to a program PRA stored in the storage device 240 to function as a control center of the video generator 20. The communication device 220 is a device that performs wireless communication or wired communication with other devices and includes, for example, an interface circuit. Specific examples of the other devices that communicate with the communication device 220 include the projector 10, the imaging device 30, and the image recognition server 40.

The microphone 230 collects user's voice. The microphone 230 outputs voice information representing the collected sound to the processing device 210. Although details will be described later, in the embodiment, the selection of the geometry with which the content to be projected from the projector 10 to the projection area SR is associated and the designation of the expression of the content are performed via the voice of the user.

The storage device 240 is a recording medium readable by the processing device 210. The storage device 240 includes, for example, a nonvolatile memory and a volatile memory. The nonvolatile memory is, for example, a read only memory (ROM), an erasable programmable read only memory (EPROM), or an electrically erasable programmable read only memory (EEPROM). The volatile memory is, for example, a random access memory (RAM). The nonvolatile memory of the storage device 240 stores various programs and a learning model file MDL.

The learning model file MDL is data corresponding to an inference model that has learned a correspondence relationship between an image generation condition and an image generated according to the generation condition. For the learning model file MDL, it is sufficient to adopt a well-known technique as appropriate. In the embodiment, by using the learning model file MDL, the processing device 210 functions as an image generation AI that generates an image of content for which an expression designated by a user is performed with a geometry designated by the user as a starting point among a plurality of geometries included in the projection area SR. The generation condition in the embodiment is a geometry associated with the content and designation of an expression of the content. In the embodiment, by the learning model file MDL, for example, the virtual frame VW is associated in advance with a contour line of the poster, and a periodic change in color (or a periodic change in width) is associated as an expression of the virtual frame VW. Although details will be described later, the user can designate a geometry associated with the content by uttering “contour line of poster”, and can designate an expression of the content associated with the geometry by uttering “color changes periodically”.

Examples of the various programs stored in the nonvolatile memory include a kernel program and the program PRA. In FIG. 3, illustration of the kernel program is omitted. The kernel program is a program for causing the processing device 210 to implement an operating system (OS). The processing device 210 reads the kernel program from the nonvolatile memory to the volatile memory when the video generator 20 is powered on and starts executing the read kernel program. When being instructed, via an input device (not illustrated), to start executing another program, the processing device 210 that operates according to the kernel program starts executing the other program. For example, when being instructed to start executing the program PRA, the processing device 210 reads the program PRA from the nonvolatile memory to the volatile memory and starts executing the program PRA read to the volatile memory.

The processing device 210 operating according to the program PRA functions as a first acquisition unit 211, a second acquisition unit 212, a third acquisition unit 213, a generation unit 214, and a display control unit 215 illustrated in FIG. 3. That is, each of the first acquisition unit 211, the second acquisition unit 212, the third acquisition unit 213, the generation unit 214, and the display control unit 215 illustrated in FIG. 3 is a software module implemented by causing the processing device 210 to operate according to the program PRA. Roles of the first acquisition unit 211, the second acquisition unit 212, the third acquisition unit 213, the generation unit 214, and the display control unit 215 illustrated in FIG. 3 are as follows.

The first acquisition unit 211 controls the projector 10 to project a predetermined image such as a white image onto the projection area SR, and controls the imaging device 30 to capture an image of the projection area SR onto which the predetermined image is projected. The first acquisition unit 211 then acquires captured image data representing the captured image obtained by capturing an image of the predetermined image projected onto the projection area SR. The predetermined image is an image for assisting object recognition by the image recognition server 40, and is an example of a second projection image in the present disclosure.

The second acquisition unit 212 transmits the captured image data acquired from the imaging device 30 to the image recognition server 40 by using the communication device 220, thereby recognizing types of various objects appearing in the captured image represented by the captured image data, recognizing planes, lines, and points (hereinafter referred to as geometries) defining contours of the objects, and acquiring geometry information indicating the recognized geometry for each recognized object. The geometry information includes information indicating a position, in the captured image, occupied by the geometry indicated by the geometry information. Based on the captured image represented by the captured image data acquired by the first acquisition unit 211 and the geometry information acquired from the image recognition server 40, the second acquisition unit 212 generates image data representing a selection assistance image that highlights the geometry indicated by the geometry information in the captured image represented by the captured image data, and causes the projector 10 to project the image represented by the image data, thereby displaying the geometry in a highlighted manner. In the embodiment, since the projection object SC appears in the captured image represented by the captured image data acquired by the first acquisition unit 211 and geometry information indicating a contour line of the projection object SC is acquired, as illustrated in FIG. 4, a selection assistance image GB, in which the contour line is highlighted with, for example, a red thick line BL and a portion other than the thick line BL is white, is projected from the projector 10 toward the projection area SR while being aligned so as to overlap the projection object SC. In FIG. 4, similarly to FIG. 2, the projection object SC is drawn by a dotted line. Similarly to the predetermined image described above, the selection assistance image GB is an example of the second projection image in the present disclosure.

The user who visually recognizes the selection assistance image GB can grasp one or more geometries included in the projection area SR at a glance. The user selects, by voice, a geometry associated with the content from among one or more geometries included in the projection area SR. As described above, in the embodiment, the user utters “contour line of poster” to designate a geometry associated with the content. When the voice is acquired by the microphone 230, the second acquisition unit 212 performs voice recognition on the voice to acquire geometry information indicating a “contour line of a poster” as geometry information indicating the geometry selected by the user (that is, the geometry associated with the content).

The third acquisition unit 213 acquires instruction information including a user instruction regarding an expression of the content associated with the geometry selected by the user. As described above, in the embodiment, the user designates the expression of the content associated with the selected geometry by uttering “periodic change in color”. When the voice is acquired by the microphone 230, the third acquisition unit 213 performs voice recognition on the voice to specify “periodic change in color” as the expression designated by the user.

The generation unit 214 generates content data representing the projection image GA to be projected onto the projection area SR from the projector 10, by using the image generation AI described above based on the geometry information acquired by the second acquisition unit 212 and the instruction information acquired by the third acquisition unit 213. For example, when the “contour line of poster” is selected as the geometry associated with the content and the “periodic change in color” is designated as the expression of the content, the generation unit 214 generates the content data representing the projection image GA showing “a virtual frame whose color changes periodically” by using the image generation AI described above.

The display control unit 215 transmits the content data generated by the generation unit 214 to the projector 10 and causes the projector 10 to project the projection image GA represented by the content data, thereby displaying the projection image GA in the projection area SR. Accordingly, in the projection area SR, the projection image GA of the content, for which the expression designated by the user is implemented with the geometry selected by the user as a starting point, is displayed. In the embodiment, the projection image GA showing the virtual frame VW whose color periodically changes is displayed around the projection object SC.

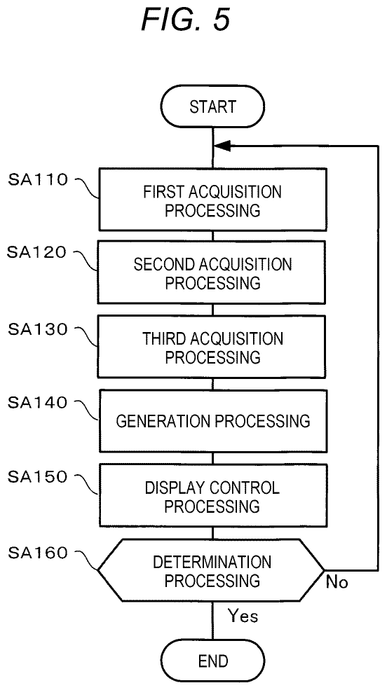

The processing device 210 operating according to the program PRA executes a display method markedly indicating the characteristics of the present disclosure. FIG. 5 is a flowchart illustrating a flow of processing in this display method. As illustrated in FIG. 5, the display method includes first acquisition processing SA110, second acquisition processing SA120, third acquisition processing SA130, generation processing SA140, display control processing SA150, and determination processing SA160.

In the first acquisition processing SA110, the processing device 210 functions as the first acquisition unit 211. In the first acquisition processing SA110, the processing device 210 controls the projector 10 to project a predetermined image such as a white image onto the projection area SR, and controls the imaging device 30 to capture an image of the projection area SR onto which the predetermined image is projected. The processing device 210 then acquires captured image data representing the captured image obtained by capturing an image of the predetermined image projected on the projection area SR.

In the second acquisition processing SA120 following the first acquisition processing SA110, the processing device 210 functions as the second acquisition unit 212. In the second acquisition processing SA120, the processing device 210 inputs the captured image data acquired from the imaging device 30 to the image recognition server 40 to recognize types of various objects appearing in the captured image represented by the captured image data, and acquires, from the image recognition server 40, geometry information representing points, lines, and planes (hereinafter collectively referred to as a geometry) included in a range of the captured image. Next, based on the captured image represented by the captured image data acquired in the first acquisition processing SA110 and the geometry information acquired from the image recognition server 40, the processing device 210 generates image data representing the selection assistance image GB that highlights the geometry indicated by the geometry information in the captured image represented by the captured image data, and causes the projector 10 to project the image represented by the image data, thereby displaying the geometry in a highlighted manner.

The user who visually recognizes the selection assistance image GB selects, by voice, a geometry associated with the content from among one or a plurality of geometries included in the projection area SR. In the second acquisition processing SA120, the processing device 210 specifies the geometry selected by the user by acquiring voice information representing voice of the user from the microphone 230.

In the third acquisition processing SA130, the processing device 210 functions as the third acquisition unit 213. In the third acquisition processing SA130, the processing device 210 acquires instruction information including a user instruction regarding an expression of the content associated with the geometry indicated by the geometry information acquired in the second acquisition processing SA120.

In the generation processing SA140, the processing device 210 functions as the generation unit 214. In the generation processing SA140, the processing device 210 generates content data representing the projection image GA to be projected on the projection area SR from the projector 10, by using the image generation AI described above based on the geometry information acquired in the second acquisition processing SA120 and the instruction information acquired in the third acquisition processing SA130. The content data generated in the generation processing SA140 of the embodiment represents the projection image GA of the content, for which the expression designated by the user is implemented with the geometry selected by the user as a starting point.

In the display control processing SA150 following the generation processing SA140, the processing device 210 functions as the display control unit 215. In the display control processing SA150, the processing device 210 transmits the content data generated in the generation processing SA140 to the projector 10 and causes the projector 10 to project an image represented by the content data, thereby displaying the projection image GA. Accordingly, in the projection area SR, the projection image GA of the content, for which the expression designated by the user is implemented with the geometry selected by the user as a starting point, is displayed.

In the determination processing SA160 following the display control processing SA150, the processing device 210 determines whether end of display of the projection image GA is instructed by the user. When end of display of the projection image GA is instructed by the user, a determination result of the determination processing SA160 is “Yes”. When the determination result of the determination processing SA160 is “Yes”, the processing device 210 ends the execution of the display method. On the other hand, if end of display of the projection image GA is not instructed by the user, the determination result of the determination processing SA160 is “No”. When the determination result of the determination processing SA160 is “No”, the processing device 210 executes the first acquisition processing SA110 and the subsequent processing again.

As described above, according to the embodiment, even when the projection object SC is a two-dimensional object, the user can select a contour line of the object as a geometry associated with content and designate an expression of the content, whereby the projection image GA of the content for which the expression is executed with the geometry as a starting point can be displayed in the projection area SR.

### 2. Other Embodiments

(1) The instruction regarding the expression of the content is input by the voice of the user in the embodiment described above, and may be input by a gesture of the user. For example, a table in which a gesture of the user and an expression of content are associated with each other may be stored in the video generator 20 in advance, and the processing device 210 may specify the gesture of the user by performing image recognition on a captured image obtained by capturing an image of the user by using the imaging device 30, who designates the expression of the content by gesture, and specify the expression of the content based on the specified gesture and the table.

(2) The geometry associated with the content is selected by the user in the embodiment described above. Alternatively, a geometry not associated with the content may be selected by the user, and in this case, content data is generated by the generation unit 214 for the projection area SR excluding the geometry selected by the user. According to this aspect, it is possible to generate and display content corresponding to a real space by designating the geometry not associated with the content. In the embodiment described above, the geometry included in the projection area SR is displayed in a highlighted manner by the display of the selection assistance image GB, and the highlighted display is not essential and may be omitted.

(3) The selection of the geometry associated with the content may be performed by the user touching the geometry in the projection area SR with a finger or an indicator such as a pointing stick, and in this case, the geometry associated with the content may be specified by analyzing a captured image of the projection area SR in a state in which the geometry associated with the content is designated by the user. The indicator may be a virtual indicator such as laser light emitted from a laser pointer. In a case where the video generator 20 includes a touch panel that includes a display device such as a liquid crystal display and a touch sensor covering a display surface of the display device, a captured image of the projection area SR may be displayed on the display device, and the user may perform a touch operation such as tracing any geometry displayed on the display device with a finger or the like to select the geometry associated with the content. According to this aspect, the user can directly select the geometry associated with the content.

### 3. Modifications

The embodiments described above can be modified as follows.

(1) In addition to the content data, the generation unit 214 may generate voice data corresponding to a geometry indicated by the geometry information acquired by the second acquisition unit 212 and an instruction indicated by the instruction information acquired by the third acquisition unit 213. The display control unit 215 may display a content image and output voice represented by the voice data generated by the generation unit 214.

(2) The first acquisition unit 211, the second acquisition unit 212, the third acquisition unit 213, the generation unit 214, and the display control unit 215 in the embodiment described above are software modules. However, any one, any two, any three, any four, or all of the first acquisition unit 211, the second acquisition unit 212, the third acquisition unit 213, the generation unit 214, and the display control unit 215 may be hardware modules such as an application specific integrated circuit (ASIC). Even if at least one of the first acquisition unit 211, the second acquisition unit 212, the third acquisition unit 213, the generation unit 214, and the display control unit 215 is a hardware module, the same effects as the effects of the embodiment described above are achieved.

(4) The program PRA may be created alone and may be provided for payment or free of charge. Specific forms of providing the program PRA include a form of providing the program PRA by writing the program PRA in a computer-readable recording medium such as a flash ROM and a form of providing the program PRA by download through an electric communication line such as the Internet. By operating a general computer according to the program PRA provided in these forms, the computer can execute the display method of the present disclosure. Further, in the embodiment described above, the imaging device 30 is a device separate from the projector 10 and is also a device separate from the video generator 20. Alternatively, the imaging device 30 may be provided in the projector 10 or may be provided in the video generator 20.

### 4. Summary of Present Disclosure

The present disclosure is not limited to the embodiment and the modifications described above and can be implemented in various aspects without departing from the gist of the present disclosure. For example, the present disclosure can also be implemented by the following aspects. In order to solve a part or all of the problems of the present disclosure or to achieve a part or all of the effects of the present disclosure, the technical features in the embodiment described above corresponding to the technical features in aspects described below can be replaced or combined as appropriate. The technical features can be deleted as appropriate unless the technical features are described as essential technical features in the present specification.

The present disclosure will be summarized below in the form of appendixes.

### Appendix 1

A display method according to the present disclosure includes: acquiring a captured image by capturing an image of a projection object in a real space; acquiring geometry information indicating a point, a line, or a plane selected by a user among points, lines, or planes included in a range of the captured image; acquiring instruction information representing an instruction of the user regarding content to be displayed in a projection area in which the projection object is provided; generating a first projection image regarding the content based on the geometry information and the instruction information; and projecting the first projection image onto the projection area to display the content. According to the display method of this aspect, the content corresponding to the real space can be generated and displayed.

### Appendix 2

A display method according to a more preferred aspect is the display method according to Appendix 1, in which the instruction information includes an instruction regarding an expression of the content, and the first projection image shows the content for which an expression indicated by the instruction information is implemented with a point, a line, or a plane indicated by the geometry information as a starting point. According to this aspect, it is possible to generate and display content that corresponds to the real space and for which an expression instructed by the user is implemented with a geometry in the real space as a starting point.

### Appendix 3

A display method according to a further preferred aspect is the display method according to Appendix 2, in which the user instructs an expression of the content by a gesture, and the instruction information is obtained by capturing an image of a gesture of the user. According to this aspect, the user can instruct, by a gesture, the expression of the content that corresponds to the real space and for which the expression is implemented with a geometry in the real space as a starting point.

### Appendix 4

A display method according to another preferred aspect is the display method according to Appendix 1, in which the generating the first projection image includes generating the first projection image for a projection area excluding a point, a line, or a plane indicated by the geometry information. According to this aspect, the user can designate, by selecting a geometry, an area not desired to be associated with the content.

### Appendix 5

A display method according to another preferred aspect is the display method according to any one of Appendix 1 to Appendix 3, in which the point, the line, or the plane included in the range of the captured image is selected based on voice of the user. According to this aspect, the user can select the geometry information by voice, and an input operation with a finger is not required.

### Appendix 6

A display method according to another aspect of the present disclosure is the display method according to any one of Appendix 1 to Appendix 3, in which the point, the line, or the plane included in the range of the captured image is selected by pointing a point, a line, or a plane in the projection area with an indicator in the real space. According to this aspect, the user can directly select the geometry.

### Appendix 7

A display method according to another preferred aspect is the display method according to any one of Appendix 1 to Appendix 3, in which the point, the line, or the plane included in the range of the captured image is selected by a touch operation on a display surface of a display device that displays the captured image. According to this aspect, the user can directly select the geometry.

### Appendix 8

A display method according to another preferred aspect is the display method according to any one of Appendix 1 to Appendix 6, further including: identifying a point, a line, or a plane included in the projection area based on the captured image; and projecting a second projection image for highlighting the identified point, line, or plane onto the projection area before acquiring the geometry information. According to this aspect, a geometry recognized based on the captured image can be presented to the user in an easy-to-understand manner.

What is claimed is:

1. A display method comprising:
acquiring a captured image by capturing an image of a projection object in a real space;
acquiring geometry information indicating a point, a line, or a plane selected by a user among points, lines, or planes included in a range of the captured image;
acquiring instruction information representing an instruction of the user regarding content to be displayed in a projection area in which the projection object is provided;
generating a first projection image regarding the content based on the geometry information and the instruction information; and
projecting the first projection image onto the projection area to display the content.

2. The display method according to claim 1, wherein
the instruction information includes an instruction regarding an expression of the content, and
the first projection image shows the content for which an expression indicated by the instruction information is implemented with the point, the line, or the plane indicated by the geometry information as a starting point.

3. The display method according to claim 2, wherein
the user instructs an expression of the content by a gesture, and
the instruction information is obtained by capturing an image of a gesture of the user.

4. The display method according to claim 1, wherein
the generating the first projection image includes generating the first projection image for a projection area excluding the point, the line, or the plane indicated by the geometry information.

5. The display method according to claim 1, wherein
the point, the line, or the plane included in the range of the captured image is selected based on voice of the user.

6. The display method according to claim 1, wherein
the point, the line, or the plane included in the range of the captured image is selected by pointing a point, a line, or a plane in the projection area with an indicator in the real space.

7. The display method according to claim 1, wherein
the point, the line, or the plane included in the range of the captured image is selected by a touch operation on a display surface of a display device that displays the captured image.

8. The display method according to claim 1, further comprising:
identifying a point, a line, or a plane included in the projection area based on the captured image; and
projecting a second projection image for highlighting the identified point, line, or plane onto the projection area before acquiring the geometry information.
